(19) United States
(12) Patent Application Publication
(10) Pub. No.: US 2003/0053516 A1
(43) Pub. Date: Mar. 20, 2003

(54) Transducer assembly

(76) Inventor: Eric Atherton, Witney (GB)

Correspondence Address: LAHIVE & COCKFIELD, 28 STATE STREET, BOSTON, MA, 02109, US

(21) Appl. No.: 10/246,993

(22) Filed: Sep. 19, 2002

(30) Foreign Application Priority Data
Sep. 19, 2001 (GB) 0122554.9

(51) Int. Cl. G01K 13/00; G01L 11/00; G01K 11/22; G01L 19/04

(52) U.S. Cl. 374/143; 374/117; 374/170; 73/702; 73/708

(57) ABSTRACT

A transducer assembly for measurement of downhole temperature and (if required) pressure includes a crystal resonator responsive to temperature and a pair of temperature sensors such as thermocouples or RTDs. One sensor is located with the crystal resonator and the other is exposed to external conditions such as those adjacent the pressure resonator. Thus, the sensors provide a correction signal for the resonator and allow improvement in the transient response of the transducer. A feedback circuit for correcting the resonator output is also disclosed.

### FIELD OF THE INVENTION

The present invention relates to a transducer assembly.

### BACKGROUND ART

Transducer assemblies are required for returning information as to (for example) temperature and pressure. A situation which present particular difficulty is in the reporting of conditions downhole in, for example, oil, gas, geothermal and other wells. The conditions of elevated temperature and pressure require a robust transducer which is able to offer an adequate service life and a reliable signal over that life.

Downhole sensors are often based on crystal resonators, typically quartz. These can be cut (or otherwise selected and designed) so as to exhibit a resonant frequency which is responsive to ambient temperature, ambient pressure, neither, or a combination of both. Thus, a crystal resonator can be excited and will resonate at a frequency which, if measured, will give information as to the downhole conditions. Given the high frequencies at which the resonator operates, its signal is usually mixed with the signal of a reference resonator to produce a signal whose frequency range covers more readily measurable frequencies. The reference resonator would ideally have no temperature response, but in practice will usually have a small response. Nevertheless, so long as the reference resonator has a different temperature response as compared to the first resonator, a meaningful signal can be extracted.

A third resonator is usually provided at the same ambient temperature but exposed to outside pressure via a suitable medium. The signal from this resonator can be mixed with that of the reference resonator in the same way. Transducers can thus comprise a temperature crystal, a pressure crystal, and a reference crystal.

Resonant transducers of this type are described in U.S. Pat. No. 5,231,880 (Ward et al)., U.S. Pat. No. 3,335,949 (Elwood et al), and U.S. Pat. No. 4,802,370 (Eernisse et al).

To protect the reference crystal and the temperature crystal from damage due to the external pressure, a housing is provided which is sufficiently robust to withstand the forces involved. The pressure crystal will typically be located in a compartment connected to the high external pressure. The reference crystal and temperature crystal are typically located in another compartment. This housing, or the bulkheads between the compartments, will have a significant thermal capacity and will therefore cause a delay in the response of the transducer to transients in temperature. The present invention seeks to overcome this difficulty.

### SUMMARY OF THE INVENTION

The present invention therefore provides a transducer assembly responsive to local temperature, comprising a first crystal resonator with a frequency response dependent on local temperature, a second crystal resonator with a frequency response with respect to local temperature which differs from the first crystal resonator, and a pair of temperature sensors, the first and second crystal resonators being located within a protective housing, wherein one sensor of the pair is sensitive to temperature within the housing and the remaining sensor is sensitive to temperature external to the housing.

This allows the output of the temperature crystal to be corrected for temperature differentials between the two crystals and the real temperature of the pressure crystal to be determined. A transducer constructed in this way retains the wide temperature range of the resonator crystal-based sensors but can avoid the problems noted above. Sensors with a fine response to small differentials can be employed without those sensors having to have an adequate response to a wide variation in temperature.

The second crystal resonator is (ideally) substantially insensitive to temperature. In practice there will be a slight response, but so long as this is characterised then it can be allowed for.

It is preferred that the one sensor is within the housing and the remaining sensor is located outside the housing. This will then correspond to the locations of the crystals whose temperature is being sensed. Other arrangements are conceivable, however, in which the sensors are located elsewhere but are (for example) in a sufficiently intimate thermal contact with the crystal concerned, such as via a good thermal conductor.

The housing will typically be one of a number of compartments within a larger assembly. Different compartments will operate at different pressures, for example.

A third crystal resonator sensitive to ambient pressure can be provided. This is a common arrangement for transducers of this type. It is often the case that temperature is being measured (inter alia) to calibrate the pressure crystal which will also have a thermal response. As the pressure crystal must be exposed to the ambient pressure, it will usually be outside the housing (or compartment) containing the temperature crystal. Thus, the invention can provide more accurate calibration of such pressure crystals.

The outputs of the first and second crystal resonators are preferably mixed within the transducer assembly as high frequency signals are best dealt with locally. It is also preferred that the output of the first crystal resonator (or the mixed output of the first and second crystal resonators) is combined with the output of the sensor pair.

The frequency domain signal of the resonators can be combined by comparing it with the output of the combiner itself, and adjusting the latter if the difference is not that dictated by the voltage output of the pair of sensors. This is of course a form of feedback loop, which we have found to be stable and reliable. The combiner can convert the resonator signal and its own output into pulsed signals for comparison. Each pulse can represent a zero crossing of the frequency domain signal from which it is derived. If the pulse signals are of opposite polarity then they can be summed and integrated by way of comparison, which can also include the voltage output of the pair of sensors.

It is also preferred that, after combining, the output of the combiner is converted to a frequency domain signal. This allows the transducer to be pin-for-pin compatible with an existing transducer. The output of the second and third crystal resonators (ie the pressure and reference crystals) are also preferably mixed within the transducer assembly.

The temperature sensors are preferably thermocouples or temperature dependent resistors. The latter can be arranged in a bridge circuit together with a pair of fixed resistors.

### BRIEF DESCRIPTION OF THE DRAWINGS

An example of the present invention will now be described by way of example, with reference to the accompanying figures, in which:

FIG. 1 shows a transducer according to the present invention in section;

FIG. 2 shows in schematic form the signal processing apparatus of the transducer shown in FIG. 1; and

FIG. 3 shows an alternative circuit.

### DETAILED DESCRIPTION OF THE EMBODIMENTS

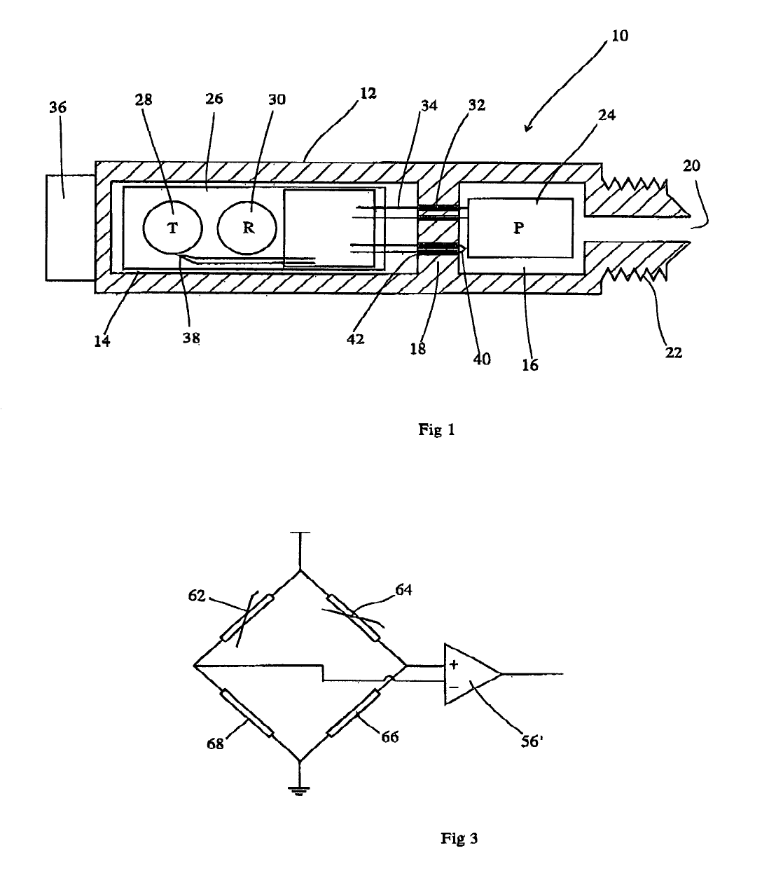

Referring to FIG. 1, the transducer assembly 10 comprises a housing 12 including a low pressure compartment 14 sealed from the process pressure and a high pressure compartment 16 connected to the process pressure to be measured. The two compartments are separated by an Internal wall 18 which is dimensioned to withstand the pressure differential involved. A port 20 leads to the high pressure compartment 16 and is threaded at 22 to accept standard connectors for pressure lines conveying liquid at the temperature and pressure to be measured.

A pressure crystal 24 is located in the high pressure compartment 16, and a circuit board 26 carrying a temperature crystal 28 and a reference crystal 30 is located in the low pressure compartment 14. Pressure feedthroughs 32 allow wires 34 through the internal wall 18 to convey signals between the circuit board 26 and pressure crystal 24.

An electrical connector 36 provides communication with the circuit board 26, allowing power to be delivered and signals to be extracted.

The operation of the resonant pressure, temperature and reference crystals is described in U.S. Pat. No. 5,231,880 and U.S. Pat. No. 3,355,949, to which reference is made and the contents of which are hereby incorporated by reference. Although the present embodiment does not work in a directly analogous manner, the above patents do give detail as to the construction and operation of the crystals employed. In particular, it is noted that the crystals resonate at a frequency that is either substantially constant (or theoretically so) in the case of the reference crystal or is characteristic of the pressure and temperature conditions. Crystals can be made to respond with different sensitivities to either temperature or pressure, and thus whilst the three crystals cannot in practice be totally selective (or completely unresponsive), the three will react differently and simultaneous equations can be established to determine the two unknowns (temperature and pressure) from the three frequencies.

Of course, in a well designed transducer the temperature and reference crystals will be isolated from the high pressure chamber by the internal wall 18 and will thus respond only to temperature. There will therefore be a difference in the frequencies which will be characteristic of a temperature. The temperature of the pressure crystal will then be known and thus the pressure can be deduced from knowledge of the resonant frequencies at that temperature.

This depends on the pressure, temperature and reference crystals all being at the same temperature. Whilst this will be true at steady state, it will not be true during periods of changing temperature, due to the thermal inertia of the housing 12 and the internal wall 18. According to the present invention, therefore, a pair of thermocouples 38, 40 are provided. A first thermocouple 38 is located adjacent the temperature crystal, whilst a second thermocouple 40 is located adjacent the pressure crystal. Feedthroughs 44 allow the wires of the thermocouple through the internal wall 18. The thermocouples therefore measure the temperature difference between the two and permit the output of the temperature crystal to be corrected.

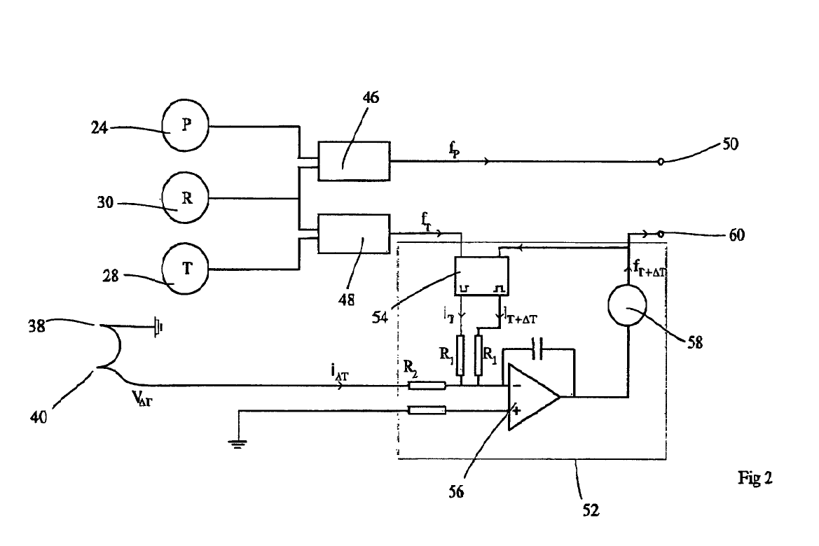

FIG. 2 shows a schematic of the signal processing. The pressure, reference and temperature crystals 24, 30, 28 are shown with signals therefrom being mixed (as is known in the prior art) by mixers 46, 48. Mixer 46 combines the signals of the pressure and reference crystals and produces a frequency domain signal fₚ at 50 that is delivered elsewhere for interpretation as a pressure level. Mixer 48 combines the signals from the temperature and reference crystals to provide a frequency domain signal f_{T} which is representative of the temperature in the vicinity of the temperature crystal. This is fed to a correction circuit 52 which produces a frequency domain output f_{T+ΔT} which is representative of the temperature at the pressure crystal.

External to the correction circuit 52 are the thermocouples 38, 40. These are arranged in series but with polarities opposed. Thus, if both are at the same temperature then the emfs generated by each are equal but opposite and the output voltage will be zero. One end of the series is grounded and the other and is provided as a temperature difference signal V_{ΔT}. The respective ends of the series are chosen such that a positive difference in temperature yields a negative voltage to the correction circuit 52.

Within the correction circuit 52, the f_{T} and f_{T+ΔT} signals are fed to a Programmable Logic Unit (PLU) 54 which is programmed to act as a two channel zero crossing detector. A first channel acts on the f_{T} signal and produces a negative voltage pulse when the frequency domain f_{T} signal shows a zero crossing. Thus, the number of pulses and hence the average (negative) voltage output on this channel will be proportional to the frequency of the f_{T} signal. A second channel acts on the f_{T+ΔT} signal and produces a positive pulse when a zero crossing is detected. Thus, the number of pulses and hence the average (positive) voltage output on this channel will be proportional to the frequency of the f_{T+ΔT} signal.

The voltage signals output on each of these channels, together with the voltage output of the thermocouple pair, are fed into a summing and integrating amplifier 56. This adds the three signals and gives a voltage output which is a time integral of the sum. That voltage is passed to a V−f converter 58 which converts it to the corresponding frequency, output as f_{T+ΔT} at 60 and fed back to the PLU 54.

The operation of the circuit will now be described. The summing integrator will stabilise when the three currents flowing sum to zero. The average current (ie smoothing the pulsed nature of the signal) flowing from the first channel of the PLU 54, ie that dealing with the f_{T} signal, will be:

$${i}_{T} = - {F}_{T} \frac{W V}{{R}_{1}} \qquad ( 1 )$$

where V is the pulse height voltage and W is the pulse width. Note that i_{T} is negative since this channel outputs a negative pulse for each zero crossing. Likewise, the average current flowing from the second channel will be:

$${i}_{T + Δ T} = + {F}_{T + Δ T} \frac{W V}{{R}_{1}} \qquad ( 2 )$$

The thermocouples are arranged so that a negative voltage V_{ΔT} is generated for a positive temperature difference ΔT between the pressure and temperature crystals, ie the pressure crystal being at a higher temperature than the temperature crystal. Thus:

V_{ΔT}=−kΔT (3)

where k is the thermocouple constant in units of V/° C. The associated current is then given by:

$${i}_{Δ T} = - \frac{k Δ T}{{R}_{2}} \qquad ( 4 )$$

If we sum the currents,

$$\begin{matrix}{F}_{T + Δ T} \frac{W V}{{R}_{1}} - {F}_{T} \frac{W V}{{R}_{1}} - \frac{k Δ T}{{R}_{2}} = 0 & ( 5 ) \\ {F}_{T + Δ T} = {F}_{T} + \frac{k Δ T}{{R}_{2}} \frac{{R}_{1}}{W V} & ( 6 ) \\ \begin{matrix}\text{is} & {F}_{T + Δ T} = {F}_{T} + C Δ T\end{matrix} & ( 7 ) \\ \begin{matrix}\text{where} & C = \frac{k {R}_{1}}{{R}_{2} W V}\end{matrix} & ( 8 )\end{matrix}$$

It is then a matter of selecting k, R₁, R₂, W and V so that C has the same value as the temperature crystal response.

It can be seen that the loop is stable since if a net positive (say) current flows into the integrator, then the output voltage will drop. This reduces the V−f frequency output, reducing the number of zero crossings, and reducing i_{T+ΔT}. This will reduce the net current and stabilise the system. Thus, the loop will stabilise to a point where the difference (if any) between the f_{T} and f_{T+ΔT} signals is governed by the signal from the thermocouples.

The operation of the circuit can also be described by considering specific examples of situations. A first situation is steady state—ie a settled system with no temperature difference. Thus, f_{T} and f_{T+ΔT} are the same, as ΔT=0. Both signals will therefore be converted into equal but opposite pulses and the net will be zero. The sum (over time) of the signals fed to the integrator 56 will be zero and its output will not change The output of the V−f converter (f_{T+ΔT}) will thus be steady and the system will remain in the same state.

A second situation arises when the temperature in the vicinity of the pressure crystal then rises slightly. This will not be reflected at the temperature crystal immediately due to the thermal inertia of the system. There will therefore be no change in f_{T} initially. As there will be a temperature differential, ΔT will be positive and V_{ΔT} will be therefore negative giving rise to a negative current flowing into the integrator from the thermocouples. As f_{T} has not changed, there will be no change in the net (zero) current from the two channels of the PLU 54. There will thus be an imbalance, in that a negative net current will flow into the integrator, and as this is based on a standard inverting amplifier the output will rise. This will cause the V−f converter to raise f_{T+ΔT}. Eventually, f_{T+ΔT} will generate more positive pulses than the negative pulses generated by f_{T}, and the PLU 54 will be causing a net positive current to flow into the integrator. This will eventually balance the net negative current i_{ΔT}, and a new steady state will be reached. In this steady state, f_{T+ΔT} exceeds by an amount governed by V_{ΔT}. Thus, the circuit is correcting f_{T} for the temperature differential between the temperature and pressure crystals.

If we than assume that the system reaches a new thermal equilibrium, is the ambient temperature around the temperature crystal rises to match that around the pressure crystal, then V_{ΔT} will fall to zero as f_{T} rises correspondingly. Thus, there is a reduction in (the negative value of) i_{ΔT} but an increase in the number of (negative) pulses generated by the f_{T} signal. These balance, leaving no net current change into the integrator, no net change in its output and no change to f_{T+ΔT}. Thus, the output of the transducer does not change, reflecting the fact that there has been no change to the actual temperature around the pressure crystal.

It is not essential to use this circuit. Other circuits or integrated circuits could perform a similar function. Indeed, no correction need be provided at the transducer itself and the V_{ΔT} signal from the thermocouples could be brought out together with the frequency domain signals from the crystals for processing elsewhere, The ΔT signal could be digitised separately and the three signals combined in firmware or software. In a simple arrangement, the V_{ΔT} signal could be used to trigger an indicator or alarm when above a certain level to signify that the measured values are at a lower accuracy due to thermal errors. However, processing the signal in the transducer as described above gives a accurate signal in a transducer that can be made pin-for-pin compatible with an existing transducer.

Another advantage of extracting the V_{ΔT} signal from the transducer is that it can be used (for example in software) to detect long term drift of the thermocouple output. As the long term average of ΔT will be zero, a very low pass filter output of V_{ΔT} should be zero and the use of such a filter (with a time period of at least an hour and preferably greater than 24 hours) can provide a correction signal.

FIG. 3 shows an alternative arrangement not relying on thermocouples. Instead, a pair of temperature dependent resistors (RTDs) 62, 64 are provided, one located adjacent the temperature crystal and one adjacent the pressure crystal. These are arranged in a bridge circuit with two other calibration resistors 66, 68 to give a voltage difference which varies with the temperature difference. This is fed to the summing and integrating amplifier 56′. The remainder of the circuit is as shown in FIG. 2.

It will be appreciated by those skilled in the art that many variations may be made to the above-described embodiments without departing from the scope of the present invention. For example, although three separate crystal resonators are shown, these could be combined such as is shown in U.S. Pat. No. 4,872,765. In this document, the temperature and reference signals are supplied by different harmonics of the same physical crystal.

In another alternative arrangement, the PLU 54 could be re-configured to issue a train of pulses whose sign and magnitude is dependent on the sign and magnitude of an f_{ΔT} signal that was the difference between f_{T} and f_{T+ΔT}. This would avoid any need to match the resistances R₁ and to match the pulse widths of the i_{T} and i_{T+ΔT} signals. The magnitude of the pulse train is of course dependent on the pulse height, width and frequency.

1. A transducer assembly responsive to local temperature, comprising;
a first resonator means with a frequency response dependent on local temperature;
a second resonator means with a frequency response with respect to local temperature which differs from the first resonator means; and
a pair of temperature sensors;
the first and second resonator means being located within a protective housing; wherein
one sensor of the pair is sensitive to temperature within the housing and the remaining sensor is sensitive to temperature external to the housing.

2. A transducer assembly according to claim 1 in which the second resonator means is substantially insensitive to temperature.

3. A transducer assembly according to claim 1 in which the one sensor is within the housing.

4. A transducer assembly according to claim 1 in which the remaining sensor is located outside the housing.

5. A transducer assembly according to claim 1 in which the housing is a compartment within a larger assembly.

6. A transducer assembly according to claim 1 including a third resonator means, the third resonator means being sensitive to pressure.

7. A transducer assembly according to claim 1 in which the outputs of the first and second resonator means are mixed within the transducer assembly.

8. A transducer assembly according to claim 1 in which the output of the first resonator means is combined with the output of the pair of sensors.

9. A transducer assembly according to claim 7 in which the mixed output of the first and second resonator means is combined with the output of the pair of sensors.

10. A transducer assembly according to claim 9 in which the frequency domain signal of the resonators is combined by comparing it with the output of the combiner and adjusting the latter if the difference is not that dictated by the voltage output of the pair of sensors.

11. A transducer assembly according to claim 10 in which the combiner converts the resonator signal and its own output into at least one pulsed signal for comparison.

12. A transducer assembly according to claim 11 in which each pulse represents a zero crossing of a frequency domain signal from which it is derived.

13. A transducer assembly according to claim 12 in which two pulse signals of opposite polarity are derived, one from the frequency domain signal of the resonators and the other from the output of the combiner, which are then summed and integrated by way of comparison.

14. A transducer assembly according to claim 13 in which the voltage output of the pair of sensors and the pulsed signals are summed and integrated.

15. A transducer assembly according to claim 10 in which, after combining, the output of the combiner is converted to a frequency domain signal.

16. A transducer assembly according to claim 6 in which the output of the second and third resonator means are mixed within the transducer assembly.

17. A transducer assembly according to claim 1 in which the temperature sensors are thermocouples.

18. A transducer assembly according to claim 1 in which the temperature sensors are temperature dependent resistors.

19. A transducer assembly according to claim 18 in which the temperature dependent resistors are arranged in a bridge circuit together with a pair of fixed resistors.

20. A transducer assembly according to claim 1 in which the resonator means are crystal resonators.
